(19) United States
(12) Patent Application Publication
(10) Pub. No.: US 2007/0067644 A1
(43) Pub. Date: Mar. 22, 2007

(54) Memory control unit implementing a rotating-key encryption algorithm

(75) Inventors: William Thomas Flynn, Rochester, MN (US); David Alan Shedivy, Rochester, MN (US); William P. Posey, Palos Verdes Estates, CA (US); Mark E. Marson, Redondo Beach, CA (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 11/213,587

(22) Filed: Aug. 26, 2005

(51) Int. Cl. G06F 12/14

(52) U.S. Cl. 713/189

(57) ABSTRACT

A method, a computer program product and a memory control unit operate to store encrypted data in a memory. In response to receiving a memory write command having write data and a memory address, a determination is made if a corresponding region of the memory is specified to store encrypted data. If the corresponding region of the memory is specified to store encrypted data, the method and computer program product retrieve an encryption key predefined for use with the received memory address and retrieve a write counter associated with the write data, increment a value of the write counter, construct data so as to include at least a portion of the memory address, a current value of the write counter and a fill pattern, and apply the constructed data to a first input of an encryption algorithm and apply the retrieved encryption key to a second input of the encryption algorithm. The method and computer program product further apply, such as by Exclusive-ORing, an output of the encryption algorithm to the write data to produce a result and send the result to the memory.

### TECHNICAL FIELD

This invention relates generally to data processing systems and memory systems and, more specifically, relate to memory control circuits and methods, including circuits and methods related to data encryption and decryption.

### BACKGROUND

In some data processing applications it is desirable to provide that information stored in a memory be secure from unauthorized reading and/or alteration. The information can include data, such as data stored in a database that relates to individuals, such as social security numbers, credit card numbers and other sensitive information. The information stored in the memory can also include executable programs, data structures and other logical constructs.

One example of a conventional approach to addressing this issue is U.S. Pat. No. 6,910,094, “Secure Memory Management Unit Which Uses Multiple Cryptographic Algorithms”, Eslinger et al. Another example is found in U.S. Patent Application Publication 2005/0021986, “Apparatus and Method for Memory Encryption with Reduced Decryption Latency”, Graunke et al., which describes a CPU that includes memory encryption/decryption logic. In this approach a method includes reading an encrypted data block from memory. During reading of the encrypted data block, a keystream used to encrypt the data block is regenerated according to one or more stored criteria of the encrypted data block. Once the encrypted data block is read, the encrypted data block is decrypted using the regenerated keystream.

A further approach is described in publication: “Improving Memory Encryption Performance in Secure Processors”, Jun Yang et al., IEEE Transactions on Computers, Vol. 53, No. 5, May 2005, which proposes a “pseudo-one-time-pad” encryption scheme employing a seed derived from an address of a value, and a mutation of the seed with a sequence number associated with an address, where the sequence number is updated each time that it is used. An on-chip sequence number cache is used is used to store sequence numbers for each cache line that goes off-chip

### SUMMARY OF THE PREFERRED EMBODIMENTS

The foregoing and other problems are overcome, and other advantages are realized, in accordance with the embodiments of this invention.

In accordance with a first aspect of this invention there is provided a method and a computer program product that operate to store encrypted data in a memory. In response to receiving a memory write command having write data and a memory address, a determination is made if a corresponding region of the memory is specified to store encrypted data. If the corresponding region of the memory is specified to store encrypted data, the method and computer program product retrieve an encryption key predefined for use with the received memory address and retrieve a write counter associated with the write data, increment a value of the write counter, construct data so as to include at least a portion of the memory address, a current value of the write counter and a fill pattern, and apply the constructed data to a first input of an encryption algorithm and apply the retrieved encryption key to a second input of the encryption algorithm. The method and computer program product further apply, such as by Exclusive-ORing, an output of the encryption algorithm to the write data to produce a result and send the result to the memory.

In accordance with a second aspect of this invention there is provided a method and a computer program product to read encrypted data from a memory. In response to receiving a memory read command comprising a memory address of data to be read, a determination is made if a corresponding region of the memory is specified to store encrypted data. If the corresponding region of the memory is specified to store encrypted data, the method and computer program product retrieve an encryption key predefined for use with the received memory address and retrieve a write counter associated with the stored data, construct data to comprise at least a portion of the memory address, a value of the write counter and a fill pattern, apply the constructed data to a first input of an encryption algorithm and apply the retrieved encryption key to a second input of the encryption algorithm. The method and computer program product further apply, such as by Exclusive-ORing, an output of the encryption algorithm with encrypted data read from the memory to produce an unencrypted result, and send the unencrypted result to an originator of the memory read command.

In accordance with a further aspect of this invention there is provided a memory control unit that comprises an input to receive a memory write command comprising write data and a memory address, and that further comprises means, responsive to the write command, for determining if a corresponding region of the memory is specified to store encrypted data and, if the corresponding region of the memory is specified to store encrypted data, for retrieving an encryption key predefined for use with the received memory address and a write counter value associated with the write data. The memory control unit further comprises means for incrementing and storing the value of the write counter and for constructing data to comprise at least a portion of the memory address, the incremented value of the write counter and a fill pattern, and further comprising means for applying the constructed data and the retrieved encryption key to encryption means, and for applying a mask output from the encryption means to the write data to produce an encrypted result.

In accordance with a still further aspect of this invention there is provided a memory control unit that comprises an input to receive a memory read command comprising a memory address of data to be read, and that further comprises means, responsive to the read command, for determining if a corresponding region of the memory is specified to store encrypted data and, if the corresponding region of the memory is specified to store encrypted data, for retrieving an encryption key predefined for use with the received memory address and a value of a write counter associated with the stored data for constructing data to comprise at least a portion of the memory address, a value of the write counter and a fill pattern. The memory control unit further includes means for applying the constructed data and the retrieved encryption key to encryption means and for applying a mask output from the encryption means to encrypted data read from the memory to produce an unencrypted result to be returned to an originator of the memory read command.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a block diagram of a data processing system having at least one master (data processor), and a memory control unit (MCU) that incorporates an encryption/decryption engine (EDE) for a computer system memory;

FIG. 2 is a more detailed block diagram of the MCU of FIG. 1;

FIG. 3 shows a plurality of Device Control Register (DCR) registers that form a part of the MCU, and also shows memory mapped registers;

FIG. 4 shows the configuration of the EDE during a memory write operation to encrypted memory;

FIG. 5 shows the configuration of the EDE during a memory read operation from encrypted memory;

FIG. 6 is a logic flow diagram that is useful in understanding the operation of the EDE during the memory write operation of FIG. 4; and

FIG. 7 is a logic flow diagram that is useful in understanding the operation of the EDE during the memory read operation of FIG. 5.

### DETAILED DESCRIPTION OF THE PREFERRED EMBODIMENTS

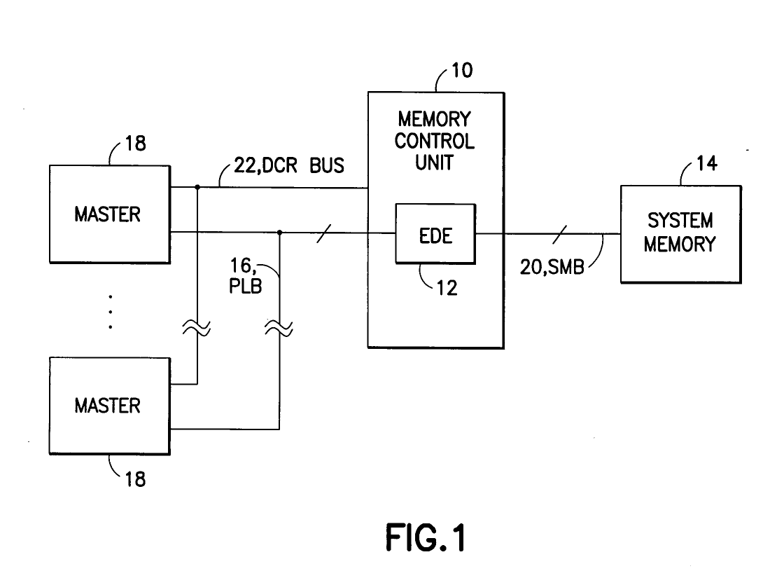

Referring to FIG. 1, exemplary embodiments of this invention relate to a memory control unit (MCU) 10 that incorporates an encryption/decryption engine (EDE) 12 for a computer system memory 14. The memory control unit 10 is highly configurable by software to allow tradeoffs to be considered at system initialization and during runtime, allowing the system designer to provide the required levels of system performance and system security within the constraints of allowable usage of the system memory 14. The MCU 10 operates at a double data rate (DDR) by outputting and inputting a 256-bit data word, 128 bits at a time.

The memory control unit 10 operates to decode requests on a processor local bus (PLB) 16, originating from one or more data processors, also referred to as masters 18, in the computer system. Through a sequence of logical steps, a request is decoded to determine if it accesses a portion of the system memory 14 that is defined to be encrypted memory, and if so, the necessary information to perform the encryption/decryption is collected. For an encrypted memory read operation, the data is read over a system memory bus (SMB) 20 and is eventually returned to the requesting master 18 in raw (unencrypted) form. For an encrypted memory write, the data is stored in the memory 14 (e.g., in synchronous dynamic random access memory (SDRAM)) over the SMB 20 after being altered by the encryption portion of the EDE 12. Non-encrypted reads and writes are handled as normal SDRAM operations and the EDE 12 is effectively bypassed. At least a portion of an encryption/decryption algorithm executed by the encryption/decryption engine 12 is programmable by software, which allows the EDE 12 to vary the encryption strength and/or the memory ranges covered based on the system and application needs. The MCU 10 may be considered to be “in-line” between the processor bus and a system memory.

The above-noted programmability of the MCU 10 may be achieved at least in part by using various device control registers (DCRs) of the MCU 10 that can be programmed via a DCR Bus 22 that is coupled to at least one of the masters 18, or possibly to some other control logic.

In an exemplary embodiment of this invention the MCU 10 and at least one of the masters 18 (as a processor core) are integrated on the same integrated circuit, such as in a System-on-a-Chip (SoC) type of architecture, where the system memory 14 may be on-chip and/or off-chip. In other exemplary embodiments the MCU 10 may be a self-contained integrated circuit that is interposed between a processor bus and the system memory 14.

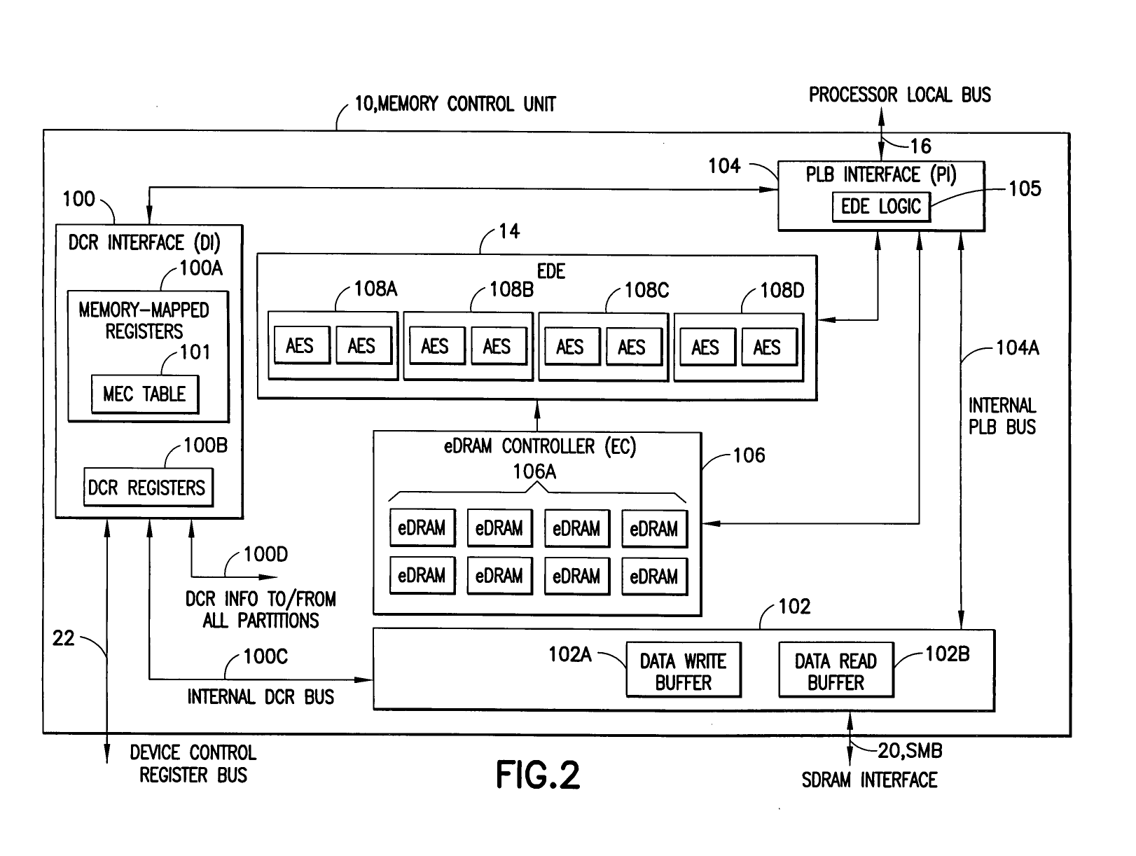

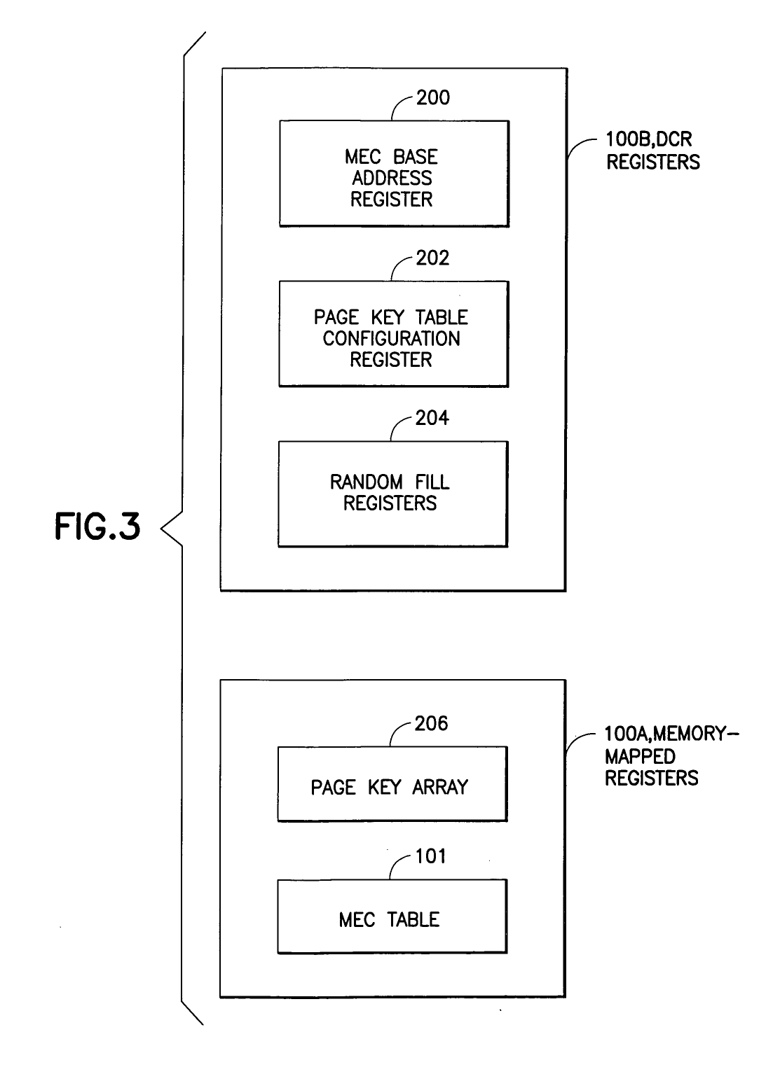

Referring also to FIG. 2, the MCU 100 can be seen to include a DCR interface 100 that includes memory-mapped registers 100A and DCR registers 100B. The memory-mapped registers 100A and DCR registers 100B include various arrays and registers for programming the encryption/decryption configuration. These include a Memory Encryption Configuration (MEC) Table 101, where each entry in the MEC Table 101 corresponds to, in a non-limiting example, a 4 MB region or partition of the system memory 14 (preferably linearly mapped). The MEC Table 101 is programmed by software with memory-mapped accesses after a MEC Base Address Register 200 (part of the DCR registers 100B, shown in FIG. 3) is set up with the desired memory base address. A given entry of the MEC Table 101 contains the following non-limiting examples of information for its corresponding address range:

Encryption enabled/disabled (one bit) for this memory segment (if disabled, memory transactions bypass the EDE 12);

Number of Checksum bytes per cacheline (0,1,2,4), where a cacheline is, in the preferred but non-limiting embodiment, 32 bytes (256 bits);

Checksum starting address (where the first checksum for the segment is stored);

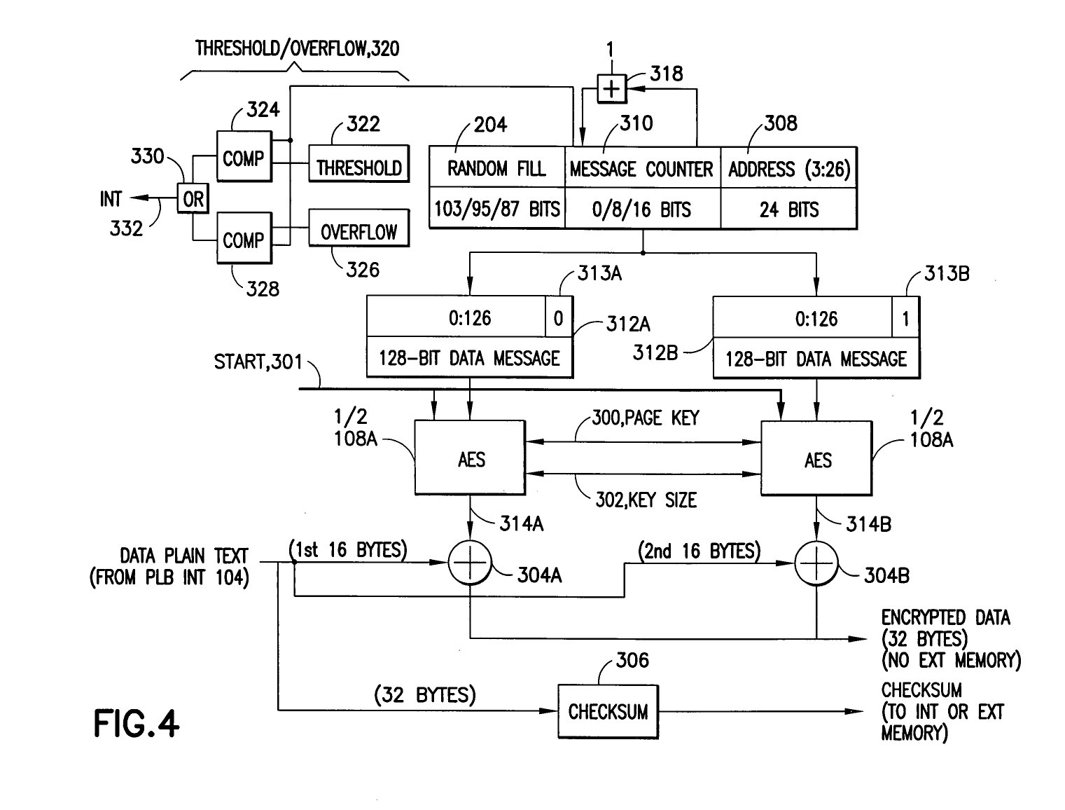

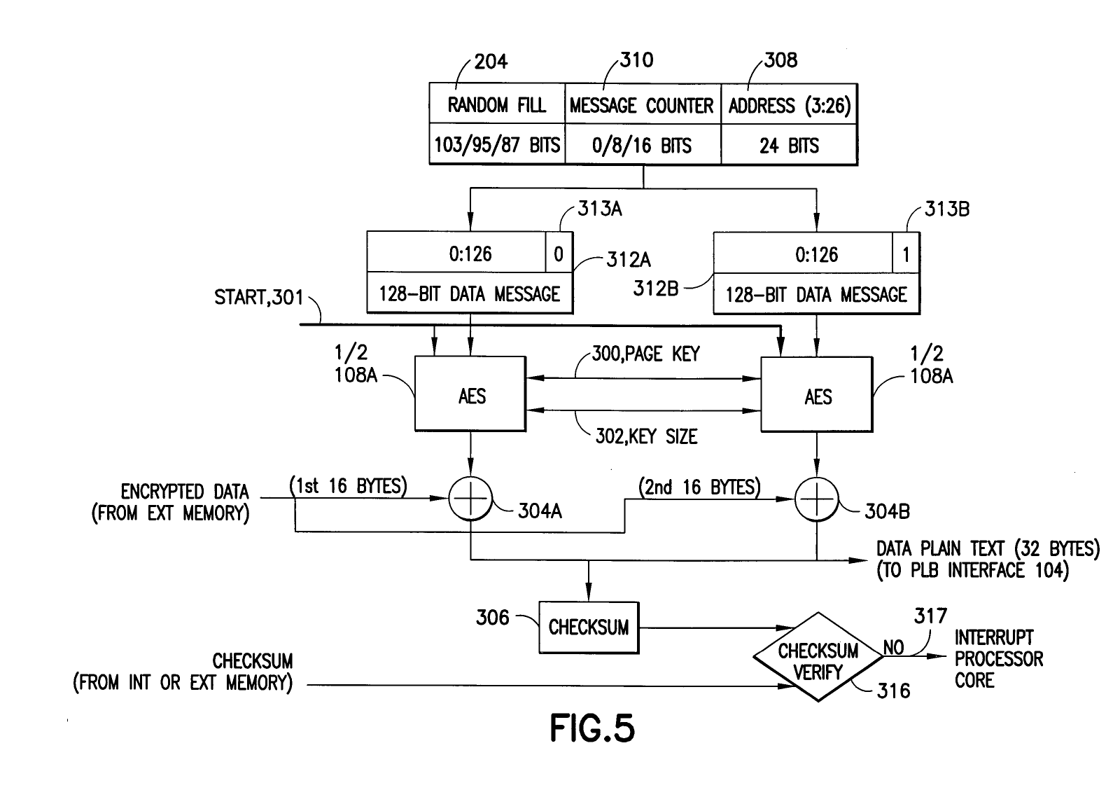

Number of Message Counter 310 bytes per cacheline (0,1,2), as shown in FIGS. 4 and 5;

Message Counter 310 starting address (where the first Message Counter value for the segment is stored); and

Disable checksum checking (where the Checksum read from memory is not checked against the new Checksum created from decrypted memory data (plain text) for memory reads, which may be useful for, as an example, system initialization purposes).

In other embodiments more or less that this specific information may be used.

In a preferred embodiment the MEC Table 101 is embodied on-chip as a low power array logic construction to allow an incoming PLB request to be immediately checked to determine whether it is encrypted or not, and to determine what other requests are required to complete the encryption/decryption (depending on the checksum and message counter configuration and access type). Other embodiments may locate the MEC Table 101 in an embedded DRAM (eDRAM) 106a, or externally in the SDRAM system memory 14. It maybe preferred to locate at least the Encryption enabled/disabled bits of the MEC Table 101 in a latch to enable even faster access, since if encryption is disabled for a region corresponding to a current memory address (read or write), then the remaining entries of the MEC Table 101 need not be accessed.

Note that while each entry in the MEC Table 101 corresponds to a fixed region size in the system memory 14 (e.g., 4 MB), in other embodiments the region sizes may be programmable, or may correspond to: (encrypted memory size/number of MEC Table 101 entries) MB. In general, the entries of the MEC Table 101 define region-by-region (e.g., for each 4 MB partition) of the system memory 14 whether the corresponding region is to contain encrypted data and, if it is, to provide various information used to enable the encryption/decryption function for that region.

The DCR registers 100B also include a Page Key Table Configuration Register 202 (see FIG. 3) that allows software to configure a Page Key Table base address, the Page Key Table size (1 K, 2K, 4K, or 8K entries), the Page Key size (128, 192, or 256 bits), and the size of encrypted system memory 14 (0, 64, 128, 256, 512 MB). Encrypted memory is defined to start at, for example, system memory 14 address zero. A single Page Key size is preferably used throughout the system, but the invention accommodates the use of different Page Key sizes. In the preferred embodiment the lower (up to) 512 MB of system memory 14 may contain encrypted 4 MB regions, although in other embodiments more than 512 MB may be used to store encrypted data.

The memory mapped registers 100A may also include the Page Key Array 206 (see FIG. 3) having characteristics defined by the Page Key Table Configuration Register 202. The Page Key Array 206 is programmed by software with memory-mapped accesses (using the base address defined in the Configuration Register 202). Each entry corresponds to a region of memory defined by: (encrypted memory size/number of page key entries). The entry size is dependent on the Page Key Size 302 (see FIGS. 4 and 5). Each entry contains a Page Key 300 (see FIGS. 4 and 5) which is used by the encryption algorithm for accesses to its associated memory region. The Page Key Array 206 may be physically located in the local eDRAM 106a for performance reasons. This allows the use of a large table size, while having a faster table lookup than a read to, for example, the external SDRAM of the system memory 14 would allow, and it also lessens SDRAM congestion.

As is shown in FIG. 3, the DCR registers 100B may also include one or more Random Fill Registers 204 that are configured by software to create a padding value that is used during the encryption/decryption process carried out by the EDE 12, as shown below in more detail in FIGS. 4 and 5.

The above data is used in conjunction with encryption/decryption algorithms of the EDE 14, such as a plurality of Advanced Encryption Standard (AES) engines 108 that are organized in pairs, with each member of the pair handling 128 bits of the 256-bit word. Reference with regard to AES may be had, for example, to Federal Information Processing Standards Publication 197, Nov. 26, 2001, “Announcing the Advanced Encryption Standard (AES)”. However, it should be appreciated that the embodiments of this invention may be practiced using other encryption techniques including, but not limited to, the Data Encryption Standard (DES). In the exemplary embodiment there are four pairs of AES algorithms or engines 108A, 108B, 108C and 108D, collectively referred to as AES engines 108, enabling four 256-bit system memory 14 read/write commands to be processed in parallel. The AES engines 108 operate in cooperation with EDE logic 105 that may be located for convenience in a PLB interface (PI) 104, and with the eDRAM 106A that is associated with an EDRAM controller (EC) 106. The eDRAM 106A stores information used by the AES engines 108, including keys and checksums. Alternatively, and as will be discussed below, some or all of this information may be stored in the system memory 14. The AES engines 108 are enabled to vary encryption strength and validation for desired memory regions, such as by changing the size of one or more parameters that form the inputs to the AES engines 108, as described in further detail below.

As is made more evident in FIG. 4, the encryption of a given 32 byte (256-bit) cacheline depends on its system memory 14 address (e.g., 24 bits of address 308, bits 3:26), its associated Message Counter 310 (if configured), the Random Fill value 204, and the Page Key 300. If configured, individual Message Counters and Checksums are associated with each cacheline within an associated region, and may be stored in contiguous arrays in either the eDRAM 106A or the SDRAM of the system memory 14, with the starting location being defined as configured, and managed by hardware (they are fetched and stored as necessary without processor intervention). The cacheline Address 308, Message Counter value 310, and Random Fill value 204 together form a 32 byte Data Message 312 (shown as Data Message 312A and 312B). Each Data Message 312A, 312B is encrypted using the Page Key 300 that is associated with the current memory region. The resulting encrypted Data Messages 314A, 314B are then Exclusively-ORed (XORed) 304A, 304B with the data plaintext (encryption during a memory write operation) or with the encrypted cacheline (decryption during a memory read operation, as in FIG. 5) to create the encrypted cacheline (encryption) or data plain text (decryption), respectively. The use of the Checksum 306 allows critical areas to be validated by comparing the checksum created the last time the cacheline was encrypted (on its way to the SDRAM of the system memory 14) with the checksum calculated after decryption.

To complete the description of FIG. 2, the EC 106 operates with, as a non-limiting example, up to eight physical eDRAMS 106A each having 2 MB of memory plus ECC for a total of 16 MB of addressable memory. The eDRAM 106a memory 106A can be accessed by any Master 18 via the PLB Interface 104, or by the internal logic to read the stored Page Keys, read/write Checksums and read/write Message Counters.

Data flowing to and from the system memory 14 is accommodated by DDR write and read buffers 102A, 102B. The on-chip data bus is referred to as the internal PLB bus 104A. In addition, there are a number of on-chip control-related buses 100C, 100D, 104B and 104C for coupling together the various major functional blocks as illustrated.

Discussing the memory encryption/decryption aspects of the invention now in further detail, MCU 10 supports memory encryption/decryption using the AES engines 108, although in other embodiments other types of encryption standards may be accommodated, as was noted above. In the exemplary embodiments shown in FIGS. 4 and 5 encryption/decryption is performed on 128-bit (16-byte, one half of a cacheline) pieces of data. Referring again to the encryption operation depicted in FIG. 4, which shows by example the AES engine pair 108A, the AES engine pair 108A is provided with a 128-bit, 192-bit, or a 256-bit Page Key 300 from the Page Key Array 206, the Page Key Size 302, and a 128-bit Data Message (e.g., data plain text from the PLB 104). The AES pair 108A performs AES-compatible encryption on the Data Messages 312A, 312B for both system memory 14 writes and read (FIG. 5). The output 314A, 314B of each AES engine of the AES pair 108A is the 128-bit Mask that is XORed (via XORs 304A, 304B) with the 128-bit Memory Data (plain text) to produce the 128-bit encrypted data for memory writes, and is XOR'd with the 128-bit encrypted data read from system memory 14 to produce the 128-bit Memory Data (plain text) for memory reads. Note that in other embodiments an AES engine may be capable of operation on more or less than 128-bit data, and corresponding less or more AES engines may be used. For example, if an AES engine is capable of operation with 256-bits, then each AES engine pair (e.g., 108A) can be replaced with a single AES engine.

During memory encryption, the Checksum may be generated in the Checksum block 306 and stored in either the eDRAM 106A or the SDRAM memory 14. During decryption, and if a Checksum exists, it is checked against the decrypted data (plain text) to verify correct data.

As was noted above, the amount of system memory 14 that may be encrypted (Mem Encrypted) is programmable and starts with address 0, with valid sizes being, for example, 0, 64 MB, 128 MB, 256 MB and 512 MB. Memory encryption/decryption is performed for PLB memory operations that are an 8-word line transfer (32-bytes, also referred to herein as the cacheline), or for a quadword burst transfer that is both on a 32-byte boundary and that has a length is a multiple of 32 bytes. All PLB Masters 18 are assumed to programmed by software to conform to these parameters when accessing encrypted memory. If a PLB Read or Write request to encrypted memory is received, and it does not meet the above size and address alignment restrictions, then an error signal is asserted. PLB burst operations that require encryption/decryption are partitioned into 32-byte cachelines internally with each 32-byte data chunk using its own AES engine pair 108 to perform encryption/decryption. The MCU 10 may use one of the following options when breaking up PLB burst operations on each 32-byte boundary:

inject “wait” states on the PLB read/write data bus 104A until an AES engine pair 108 is available, where the burst is not terminated;

terminate the PLB burst operation at a current 32-byte boundary when no AES engine pair 108 is available (this requires the PLB Master 18 to resend the burst operation starting at the address where termination was received);

terminate the PLB burst operation at each 32-byte boundary (this requires the PLB Master 18 to resend the burst operation starting at the address where termination was received); or

terminate the PLB burst operation after four 32-byte cachelines are received (this requires the PLB Master 18 to resend the burst operation starting at the address where termination was received).

The above-described Message Counter 310, if used, is incremented for each memory write to a corresponding 32-byte cacheline, shown in FIG. 4 as the increment logic that includes adder 318. For a memory write operation, the Message Counter 310 associated with that cacheline is first incremented, and is then used as part of the 128-bit Data Message 312 that is sent to the AES engine 108 for encryption. For a memory read of a particular cacheline the Message Counter 310 is not incremented before being used as part of the 128-bit Data Message 312 that is sent to the AES engine 108 for a decryption operation.

It is within the scope of the exemplary embodiments of this invention to set a Message Counter threshold value so that when the Message Counter 310 value exceeds the threshold an interrupt can be generated. This enables a Master 18 or some other logic to change the Page Key 300 value, if desired, after some predetermined number of writes to the same cacheline in the system memory 14. The address of the PLB memory command that caused the interrupt to be triggered may also be stored. An interrupt may also be generated upon an occurrence of a Message Counter 310 overflow event.

Further in this regard FIG. 4 also shows threshold/overflow logic 320 that includes a programmable Threshold register 322 and associated Threshold comparator 324 for comparing the value of the Message Counter 310 to the programmed threshold value. Also provided is an Overflow register 326 (an actual register or hardwired inputs (e.g., all ones)) that has an associated Overflow comparator 328. Outputs of the comparators 324, 326 can be used to generate separate interrupt signals to the Masters 18, or as shown their outputs may be ORed to generate a single interrupt signal 332. Status is preferably saved upon the generation of the interrupt to enable the Master 18 to perform the desired interrupt handling.

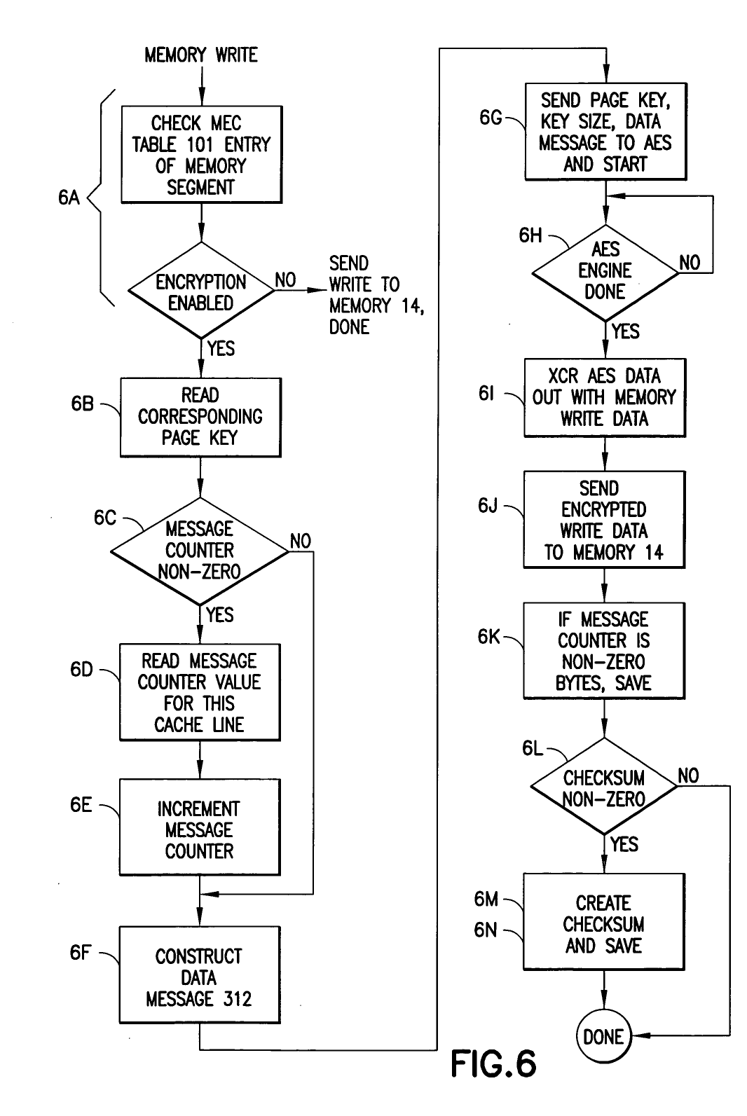

Referring now to FIG. 6, there is described a logical sequence of events to accomplish a memory encryption operation. The encryption/decryption logic preferably optimizes the sequence by executing multiple steps at the same time whenever possible.

Step 6A. Receive a memory write on the PLB interface 104, and check the corresponding 4 MB segment entry in the Memory Encryption Configuration Table 101 to determine if encryption is enabled for this 4 MB segment. If encryption is enabled the method proceeds to Step 6B, else send the memory write directly to the system memory 14.

Step 6B. Read the Page Key 300 from the eDRAM memory 106A (the Page Key 300 will be either 128, 192, or 256 bits).

Step 6C. Examine MEC Table 101 entry to determine if the Message Counter 310 value is non-zero bytes. If non-zero, go to Step 6D, else if zero bytes, go to Step 6F.

Step 6D. Using the Message Counter Address in the MEC Table 101 entry, and adding an offset based on the 32-byte cacheline index into the segment and the size of the Message Counter 310, read the Message Counter 310 value from either internal (eDRAM 106A) or the external (SDRAM) memory 14, depending on the Message Counter address calculated.

Step 6E. Once the Message Counter value has been retrieved from memory, increment the value of the Message Counter 310.

Step 6F. Construct the 128-bit Data Message 312 to be used by the AES engine 108 as follows, according to the Message Counter size as found in the MEC Table 101 entry (∥ denotes concatenation):

a) 0 byte=>Random Fill(0:102)∥Address(3:27); or

b) 1 byte=>Random Fill(0:94)∥Message Counter(0:7)∥Address(3:27); or

c) 2 bytes=>Random Fill(0:86)∥Message Counter(0:15)∥Address(3:27).

It should be noted that the 128-bit Data Message 312 will be different for each AES engine 108 of the pair because the Address field will be different, as the Address field indicates the 16-byte boundary of the 32-byte cacheline data portion that is being encrypted. Note that although address bits 3:26 are applied at 308, the address bit 27 (defining a 16 byte boundary) is forced to a zero (313A) or to a 1 (313B), thereby ensuring that the 128-bit Data Message 312 will be different for each AES engine 108 of the pair. The Random Fill value 204 is previously specified, and the same value may be initialized by software to be used for all of the encrypted segments of the memory 14.

Step 6G. Send the following information to both AES engines of the AES engine pair 108A, 108B:

a) Page Key 300 (256 bits, not all bits may be valid);

b) Key Size 302 (128, 192, or 256 bits);

c) Data Message 312 (128 bits, each AES engine receives a unique value); and

d) a Start signal 301 to begin the encryption process.

Step 6H. Wait for the AES engines 108 to indicate the encryption process is completed.

Step 6I. Use the 128-bit Data Out 314 of each of the AES engines 108 to XOR with the corresponding 128-bit memory write data.

Step 6J. Send the encrypted memory write data (256 bits) to the memory 14.

Step 6K. If the Message Counter 310 size is specified to be non-zero bytes, then send the updated Message Counter 310 value to either internal memory (eDRAM 106) or external memory (SDRAM system memory 14), depending on the Message Counter address calculated.

Step 6L. Check the MEC Table 101 entry to determine if the Checksum field indicates non-zero bytes and,

a) if non-zero bytes, go to Step 6M; else

b) if zero bytes, then Done.

Step 6M. Create the Checksum 306 for the 32-byte memory write data (plain text).

Step 6N. Using the Checksum Address in the MEC Table 101 entry, and adding an offset based on the 32-byte cacheline index into the segment and the size of the Checksum, write the Checksum value to either internal memory (eDRAM 106A) or external memory 14, depending on the Checksum address calculated. The Checksum value is retrieved and used to compare to a checksum generated on the next read of the cacheline that was just stored, as described below.

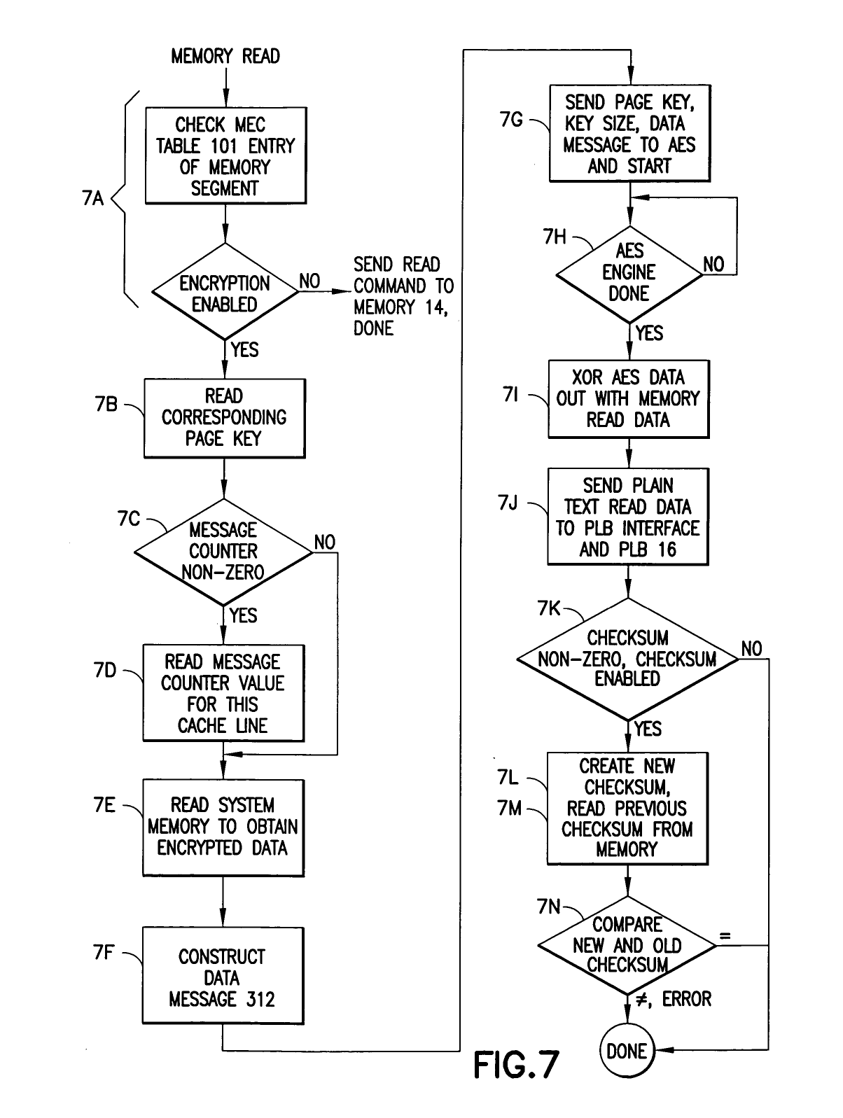

Referring now to FIG. 7, the logical sequence of events to accomplish a memory decryption operation is now described. The encryption/decryption logic preferably optimizes the sequence by executing multiple steps at the same time whenever possible.

Step 7A. Receive a memory read on the PLB interface 104, check the corresponding 4 MB segment entry in the Memory Encryption Configuration Table 101 to determine if encryption is enabled. If encryption is enabled the method proceeds to Step 7B, else send the memory read command directly to the system memory 14.

Step 7B. Read the Page Key 300 from eDRAM memory 106A (the Page Key will be either 128, 192, or 256 bits).

Step 7C. Check MEC Table 101 entry to determine if the Message Counter 310 value is non-zero bytes. If non-zero go to Step 7D, else go to Step 7E.

Step 7D. Using the Message Counter Address in the MEC Table 101 entry, and adding an offset based on the 32-byte cacheline index into the segment and the size of the Message Counter 310, read the Message Counter 310 value from either internal memory (eDRAM 106A) or external (SDRAM) memory 14, depending on the Message Counter Address that is calculated.

Step 7E. Read the system memory 14 (data read buffer 102) to obtain the encrypted memory read data.

Step 7F. Construct the 128-bit Data Message 312 to be used by the AES engine 108 as follows, according to the Message Counter size as found in the MEC Table 101 entry:

a) 0 byte==>Random Fill(0:102)∥Address(3:27); or

b) 1 byte==>Random Fill(0:94)∥Message Counter(0:7)∥Address(3:27); or

c) 2 bytes==>Random Fill(0:86)μMessage Counter(0:15)∥Address(3:27).

As was discussed above for Step 6F, the 128-bit Data Message 312 will be different for each AES engine 108 of the pair because the Address field will be different, as the Address field indicates the 16-byte boundary of the 32-byte cacheline data portion that is being encrypted. Again note that although address bits 3:26 are applied at 308, the address bit 27 (defining a 16 byte boundary) is forced to a zero (313A) or to a 1 (313B), thereby ensuring that the 128-bit Data Message 312 will be different for each AES engine 108 of the pair. The Random Fill value 204 is previously specified, and the same value may be initialized by software to be used for all of the encrypted segments of the memory 14.

Step 7G. Send the following information to both AES engines of the AES engine pair 108A, 108B:

a) Page Key 300 (256 bits, not all bits may be valid);

b) Key Size 302 (128, 192, or 256 bits);

c) Data Message 312 (128 bits, each AES engine receives a unique value); and

d) the Start signal 301 to begin the encryption process (note that even though this is a decryption operation, the AES engine 108 still performs an encryption operation.)

Step 7H. Wait for the AES engines 108 to indicate that the encryption process is completed.

Step 7I. Use the 128-bit Data Out 314 of each of the AES engines to XOR with the corresponding 128-bit encrypted memory read data.

Step 7J. Return the memory read data (plain text) to the PLB Interface 104 and, via the PLB 16, to the logic that requested the memory read operation.

Step 7K. Check MEC Table 101 entry to determine if the Checksum field indicates non-zero bytes and to determine if the Disable Checksum Checking bit is reset and,

a) if non-zero bytes and the Disable Checksum Checking bit is reset, go to Step 7L; else

b) if zero bytes or the Disable Checksum Checking bit is set, then Done.

Step 7L. Create the Checksum 306 for the memory read data (plain text).

Step 7M. Using the Checksum Address in the MEC Table 101 entry, and adding an offset based on the 32-byte cacheline index into the segment and the size of the Checksum, read the Checksum value from either the internal memory (eDRAM 106A) or the external system memory 14, depending on the Checksum address calculated.

Step 7N. Using a Checksum comparator 316 (FIG. 5), compare the new Checksum with the Checksum read from the memory 106A or 14, and if they are the same, then Done, else if they are not the same, and the error is not masked, then the plain text data is returned on the PLB interface 104 with an associated error flag set, and an interrupt signal 317 may be generated.

Based on the foregoing description it should be appreciated that the exemplary embodiments of this invention provide a combination of hardware and software that is used to perform a rotating-key algorithm for encrypting and decrypting information in a system memory 14. The method provides very high encryption with a minimal impact on memory latency. By altering the encryption variables each time data is stored externally to the chip that embodies the MCU 10 (to the system memory 14), it becomes much more difficult to use probing techniques and the like to read the encrypted data.

The encryption process is also unique to a given cacheline, as the same data stored to two different addresses is encrypted differently.

There are various pieces of hardware and software which work together to implement the rotating-key encryption algorithm. In the general case, all encryption/decryption is performed by the hardware on-the-fly, and each time a cacheline is stored to memory 14 it is encrypted differently, by including the cacheline-specific Message Counter 310 as part of the encryption message. The Message Counters 310 are maintained by hardware on a cacheline basis, without requiring software intervention. A further aspect of the invention provides an ability to generate an interrupt to the processor, such as one of the Masters 18, based on the value of the Message Counter 310, to enable software to create a completely new encryption key for a block of memory, such as by providing a new Page Key 300. In this case it is preferred that a memory block is moved and then re-encrypted. This procedure provides more complete data protection for the most sensitive pieces of memory, and occurs infrequently enough to not impact general system performance.

The MCU 10 hardware operates to determine the location of the Page Key 300 entry and read it, and read the appropriate Message Counter 310 for the new encrypted access. If the encrypted access is a memory store or write operation, the Message Counter 310 associated with the current cacheline is fetched, incremented, and then used along with at least a portion of the cacheline address 308, the Random Fill 204 data, and the Page Key 300 table entry, to encrypt the data to be stored. The Message Counter 310 is then also saved in memory (internal or external). Ifthe encrypted access is a memory fetch or read operation, the Message Counter 310 is fetched and used to decrypt the data read from memory. Further, for the memory store operation, the value of the Message Counter 310 may be compared, using threshold/overflow logic 320, to a programmable threshold value and to an overflow count value, and if either comparison finds equality the processor interrupt 332 can be generated and status information saved for use by software.

The related software creates the encrypted memory configuration, initializes the memory encryption table (MEC Table 101), and establishes the Random Fill data 204 and a starting Page Key 300 value for each memory page. If the software interrupt handler is invoked and detects that a Message Counter 310 threshold or overflow condition has occurred, then the following operations are executed. If the value stored in Threshold register 322 has been reached, the hardware status is read to determine the encrypted block that caused the interrupt; enabling the block to be re-created using a new Page Key 300 value. To accomplish this the current data in memory 14 is copied (saved) to a different region in memory, the Page Key 300 table entry is revised, all of the cacheline Message Counters 310 associated with the block are re-initialized, and then the saved data is copied back to memory 14 (which the hardware now encrypts with the new encryption values). If a Message Counter 310 overflow condition is indicated by the interrupt, the software can either consider this an error condition, or as a high-priority interrupt and handle in the same manner as the threshold event. In this case the data stored into memory 14 is still good, but further encryptions will begin reusing Message Counter 310 values that have already been used with the current Page Key 300.

It can be appreciated that these exemplary embodiments of the invention are not limited for use with memory (semiconductor and/or magnetic or optical storage device) interfaces, but could also be used with other types of interfaces, such as Peripheral Component Interfaces (PCI), where data can be probed externally but is required to be secure. The exemplary embodiments of the invention may also be used to provide a higher level of security, through the use of the rotating Message Counter and related logic, while using weaker encryption methods (e.g., smaller keys and/or simplified encryption engines), to reduce chip size, cost and complexity.

The exemplary embodiments ofthis invention may be implemented in whole or in part by computer software executable by processor, or by hardware, or by a combination of software and hardware. Further in this regard it should be noted that the various blocks of the logic flow diagrams of FIGS. 6 and 7 may represent program steps stored in a data storage medium, or interconnected logic circuits, blocks and functions, or a combination of program steps and logic circuits, blocks and functions.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. As but some non-limiting examples, the use of other data word widths, other size memory partitions (e.g., other than 4 MB), other number of bytes in a cacheline and/or other types of encryption engines may be attempted by those skilled in the art. However, all such and similar modifications of the teachings of this invention will still fall within the scope of the embodiments of this invention.

Furthermore, some of the features of the embodiments of this invention may be used to advantage without the corresponding use of other features. As such, the foregoing description should be considered as merely illustrative of the principles, teachings and embodiments of this invention, and not in limitation thereof.

What is claimed is:

1. A method to store encrypted data in a memory, comprising:
receiving a memory write command comprising write data and a memory address and determining if a corresponding region of the memory is specified to store encrypted data;
if the corresponding region of the memory is specified to store encrypted data, retrieving an encryption key predefined for use with the received memory address and retrieving a write counter associated with the write data;
incrementing a value of the counter;
constructing data to comprise at least a portion of the memory address, a current value of the write counter and a fill pattern;
applying the constructed data to a first input of an encryption algorithm and applying the retrieved encryption key to a second input of the encryption algorithm;
Exclusive-ORing an output of the encryption algorithm with the write data to produce a result; and
sending the result to the memory.

2. A method as in claim 1, further comprising saving the incremented value of the write counter.

3. A method as in claim 1, further comprising determining if checksum generation is enabled and, if it is, creating a checksum for the write data and storing the checksum for use if the result is subsequently read from the memory.

4. A method as in claim 1, further comprising comparing the counter to at least one of an overflow value and a predetermined threshold value, and generating an interrupt if the comparison indicates equality.

5. A method as in claim 4, where in response to the interrupt generated in response to the threshold value being reached, determining an encrypted memory block that caused the interrupt; and recreating the block using another encryption key.

6. A method as in claim 5, where recreating comprises re-initializing counter values associated with the block.

7. A computer program product comprising a computer useable medium including a computer readable program, wherein the computer readable program when executed on the computer causes the computer to perform operations comprising:
receiving a memory write command comprising write data and a memory address and determining if a corresponding region of the memory is specified to store encrypted data;
if the corresponding region of the memory is specified to store encrypted data, retrieving an encryption key predefined for use with the received memory address and retrieving a write counter associated with the write data;
incrementing a value of the counter;
constructing data to comprise at least a portion of the memory address, a current value of the write counter and a fill pattern;
applying the constructed data to a first input of an encryption algorithm and applying the retrieved encryption key to a second input of the encryption algorithm;
Exclusive-ORing an output of the encryption algorithm with the write data to produce a result; and
sending the result to the memory.

8. A computer program product as in claim 7, further comprising saving the incremented value of the write counter.

9. A computer program product as in claim 7, further comprising determining if checksum generation is enabled and, if it is, creating a checksum for the write data and storing the checksum for use if the result is subsequently read from the memory.

10. A computer program product as in claim 7, further comprising comparing the counter to at least one of an overflow value and a predetermined threshold value, and generating an interrupt if the comparison indicates equality.

11. A computer program product as in claim 10, where in response to the interrupt generated in response to the threshold value being reached, determining an encrypted memory block that caused the interrupt; and recreating the block using another encryption key.

12. A computer program product as in claim 11, where recreating comprises re-initializing counter values associated with the block.

13. A method to read encrypted data from a memory, comprising:
receiving a memory read command comprising a memory address of data to be read and determining
if a corresponding region of the memory is specified to store encrypted data;
if the corresponding region of the memory is specified to store encrypted data, retrieving an encryption key predefined for use with the received memory address and retrieving a write counter associated with the stored data;
constructing data to comprise at least a portion of the memory address, a value of the write counter and a fill pattern;
applying the constructed data to a first input of an encryption algorithm and applying the retrieved encryption key to a second input of the encryption algorithm;
Exclusive-ORing an output of the encryption algorithm with encrypted data read from the memory to produce an unencrypted result; and
sending the unencrypted result to an originator of the memory read command.

14. A method as in claim 13, further comprising determining if checksum checking is enabled and, if it is, creating a checksum for the unencrypted result, retrieving a checksum previously generated from corresponding write data, and comparing the two checksums.

15. A computer program product comprising a computer useable medium including a computer readable program, wherein the computer readable program when executed on the computer causes the computer to perform operations comprising:
receiving a memory read command comprising a memory address of data to be read and determining if a corresponding region of the memory is specified to store encrypted data;
if the corresponding region of the memory is specified to store encrypted data, retrieving an encryption key predefined for use with the received memory address and retrieving a write counter associated with the stored data;
constructing data to comprise at least a portion of the memory address, a value of the write counter and a fill pattern;
applying the constructed data to a first input of an encryption algorithm and applying the retrieved encryption key to a second input of the encryption algorithm;
Exclusive-ORing an output of the encryption algorithm with encrypted data read from the memory to produce an unencrypted result; and
sending the unencrypted result to an originator of the memory read command.

16. A computer program product as in claim 15, further comprising determining if checksum checking is enabled and, if it is, creating a checksum for the unencrypted result, retrieving a checksum previously generated from corresponding write data, and comparing the two checksums.

17. A memory control unit comprising an input to receive a memory write command comprising write data and a memory address, further comprising circuitry, responsive to the write command, to determine if a corresponding region of the memory is specified to store encrypted data and, if the corresponding region of the memory is specified to store encrypted data, to retrieve an encryption key predefined for use with the received memory address and a write counter associated with the write data, further comprising circuitry to increment a value of the counter, and to construct data to comprise at least a portion of the memory address, a current value of the write counter and a fill pattern; further comprising circuitry to apply the constructed data to a first input of an encryption algorithm and to apply the retrieved encryption key to a second input of the encryption algorithm, and to apply a mask that is output from the encryption algorithm to the write data to produce an encrypted result for storage in the memory.

18. A memory control unit as in claim 17, further comprising circuitry to store the incremented value of the write counter.

19. A memory control unit as in claim 17, further comprising circuitry, responsive to checksum generation being enabled, to create and store a checksum for the write data for use if the result is subsequently read from the memory.

20. A memory control unit as in claim 17, further comprising a comparator to compare a value of the write counter to at least one of an overflow value and a predetermined threshold value to generate an interrupt if the comparison indicates equality.

21. A memory control unit as in claim 20, further comprising circuitry, responsive to the interrupt being generated in response to the threshold value being reached, to recreate the memory block that causes the interrupt by using another encryption key, and to re-initialize counter values associated with the memory block.

22. A memory control unit comprising an input to receive a memory read command comprising a memory address of data to be read, further comprising circuitry, responsive to the read command, to determine if a corresponding region of the memory is specified to store encrypted data and, if the corresponding region of the memory is specified to store encrypted data, to retrieve an encryption key predefined for use with the received memory address and a write counter associated with the stored data to construct data to comprise at least a portion of the memory address, a value of the write counter and a fill pattern, to apply the constructed data to a first input of an encryption algorithm and the retrieved encryption key to a second input of the encryption algorithm; and to apply a mask that is output from the encryption algorithm to encrypted data read from the memory to produce an unencrypted result to be returned to an originator of the memory read command.

23. A memory control unit as in claim 22, further comprising circuitry, responsive to checksum checking being enabled to create a checksum for the unencrypted result, to retrieve a checksum previously generated from corresponding write data, and to compare the two checksums.

24. A memory control unit comprising an input to receive a memory write command comprising write data and a memory address, further comprising means, responsive to the write command, for determining if a corresponding region of the memory is specified to store encrypted data and, if the corresponding region of the memory is specified to store encrypted data, for retrieving an encryption key predefined for use with the received memory address and a write counter value associated with the write data, further comprising means for incrementing and storing the value of the write counter and for constructing data to comprise at least a portion of the memory address, the incremented value of the write counter and a fill pattern; further comprising means for applying the constructed data and the retrieved encryption key to encryption means, and for applying a mask output from the encryption means to the write data to produce an encrypted result.

25. A memory control unit as in claim 24, further comprising means, responsive to checksum generation being enabled, for creating and storing a checksum for the write data for use if the encrypted result is subsequently read.

26. A memory control unit as in claim 24, further comprising means for comparing the value of the write counter to at least one of an overflow value and a predetermined threshold value to generate an interrupt if the comparison indicates equality.

27. A memory control unit as in claim 26, further comprising means, responsive to the interrupt being generated in response to the threshold value being reached, for recreating the memory block that causes the interrupt by using another encryption key, and for re-initializing counter values associated with the memory block.

28. A memory control unit comprising an input to receive a memory read command comprising a memory address of data to be read, further comprising means, responsive to the read command, for determining if a corresponding region of the memory is specified to store encrypted data and, if the corresponding region of the memory is specified to store encrypted data, for retrieving an encryption key predefined for use with the received memory address and a value of a write counter associated with the stored data for constructing data to comprise at least a portion of the memory address, a value of the write counter and a fill pattern, further comprising means for applying the constructed data and the retrieved encryption key to encryption means and for applying a mask output from the encryption means to encrypted data read from the memory to produce an unencrypted result to be returned to an originator of the memory read command.

29. A memory control unit as in claim 28, further comprising means, responsive to checksum checking being enabled, for creating a checksum for the unencrypted result, and for comparing the created checksum with a checksum previously generated from corresponding write data.
